(19) United States
(12) Patent Application Publication
(10) Pub. No.: US 2012/0254526 A1
(43) Pub. Date: Oct. 4, 2012

(54) ROUTING, SECURITY AND STORAGE OF SENSITIVE DATA IN RANDOM ACCESS MEMORY (RAM)

(75) Inventor: Vydhyanathan Kalyanasundharam, San Jose, CA (US)

(73) Assignee: ADVANCED MICRO DEVICES, INC., Sunnyvale, CA (US)

(21) Appl. No.: 13/073,488

(22) Filed: Mar. 28, 2011

(51) Int. Cl. G06F 12/00

(52) U.S. Cl. 711/104; 711/E12.001

(57) ABSTRACT

A method and apparatus for securely storing and accessing processor state information in random access memory (RAM) at a time when the processor enters an inactive power state.

### FIELD OF INVENTION

This application relates to memory and methods of data storage.

### BACKGROUND

Power management is an important issue in computer design. Units operating at high clock frequencies in a computer system, such as processors, typically consume more power than other units.

There are several power management states that processors may enter. Reference is now made to the Advanced Configuration and Power Interface (ACPI) Specification, Revision 4.0a, Apr. 5, 2010, which describes various power management states. Each of the processor cores 102_N, may be initiated into various power states such as C0, C1, . . . . C6, and various others performance states such as P1 . . . Pn and others as described in the ACPI specification. A state of C0/P0 . . . Pn implies an active state in the performance range of P0 to Pn. A power state of C6 implies that the entire multi-core processor system may be power gated, while CC6 implies a specific central processing unit (CPU) core within the multi-core processor system is in an inactive, power gated state.

When processors enter an inactive power gated state, which is also referred to as an idle state, all processes in the system may halt. In order to exit the inactive power state, an interrupt or a system reset occurs. In order to seamlessly return from the inactive power state, there is a need to save the architectural state of the processor at the time the processor enters the inactive power state.

### SUMMARY OF EMBODIMENTS

A method and apparatus is presented for securely storing and accessing processor state information in random access memory (RAM) at a time when the processor enters an inactive power state.

### BRIEF DESCRIPTION OF THE DRAWINGS

FIG. 1 shows an example of a block diagram of a system;

FIG. 2 is a flow diagram of the process of allocating storage space in RAM;

FIG. 3 is a flow diagram of the process for storing state information in RAM; and

FIG. 4 is a flow diagram of a request for information sent to RAM.

### DETAILED DESCRIPTION OF THE EMBODIMENTS

Some computer systems, utilize the ACPI standard for power management and monitoring. The ACPI standard is an operating system-based specification that is targeted to regulate a computer system's power management. For instance, the ACPI standard sets processes for controlling and directing processor cores for better management of battery life. In doing so, ACPI assigns processor power states, referred to as C-states, and forces a processor to operate within the limits of these states. Central processing unit (CPU) states or “C-States” are defined as shown in Table 1 below:

TABLE 1

| CPU State | Description |
|---|---|
| C0 | Operating |
| C1 | Halt |
| C2 | Stop-Clock |
| C3 | Sleep |
| . . . | |
| Cn | Nth C-State |

It should be understood that for multiple core CPUs, each core may have an associated C-State. During normal operation, a CPU core is in the operating state “C0” and the CPU core processes instructions normally. The lower C-States (C1, C2 . . . Cn) are referred to as “idle states.” System performance may depend on the selected performance state as discussed below. A system in the C1 state (Halt) does not execute instructions, but may return to an executing state essentially instantaneously. The C1 state has the lowest latency. The hardware latency in this state is low enough that the operating system does not consider the latency aspect of the state when deciding whether to use it.

In the C2 state (Stop-Clock), the CPU core is not executing instructions, but will typically take longer to wake up compared to the C1 state. The C2 state offers improved power savings over the C1 state. In the C3 state (Sleep), the CPU core does not need to keep its cache coherent, but maintains other state information. The C3 state offers improved power savings over the C1 and C2 states. It should be understood that additional C-States may be defined without departing from the scope of this disclosure.

When a processor core is operating at a lower power state, links to the processor core may be disconnected, memory may be put into self-refresh, clocks may be turned off, voltage may be reduced and power to some parts of the processor may be turned off. Prior to entering a lower power state, the processor core may store state information. Once the current state information is saved to memory, the processor power sources may be disconnected. The lower power state may eventually be exited by the processor core via a system interrupt action or a system reset action. By saving the current state information at a time before power is disconnected, the processor core may be able to preserve the current state of the system so that a seamless recovery upon power restoration may be possible.

The system may power down by executing a HALT instruction, which is a microcode instruction, to change the operating state of the process core to a lower power state. When a HALT instruction is executed, processor cores may flush their caches and may save their current architectural state information to memory, prior to disconnecting power sources. While the current state information may be stored in local memory, a need exists to store this information securely.

A secure space in a special address range in RAM may be created so that each processor core in node of a system may maintain its state information prior to entering a lower power state. The secure space in RAM is not freely accessible and may only be accessed by microcode.

While the embodiments below are described in the context of ACPI for purposes of illustration, the embodiments are not limited to ACPI. Other power state schemes may instead be employed.

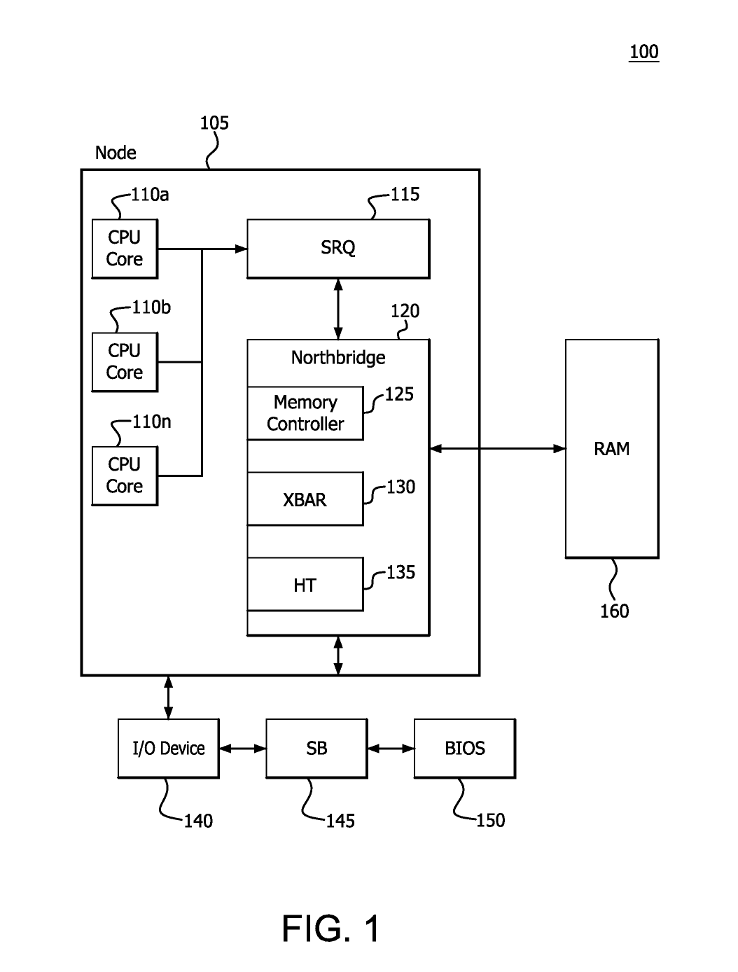

FIG. 1 shows an example of a block diagram of a system 100 in accordance with one embodiment. The system 100 may include one or more nodes 105. A node 105 is an integrated circuit device that may include one or more processor cores 110a-110n. A processor core may execute one or more threads (i.e., processes) in parallel, and may be any one of a variety of processor cores such as a central processing unit (CPU) core or a graphics processing unit (GPU) core.

For instance, they may be x86 processor cores that implement x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processor cores are contemplated, such as Digital Signal Processors (DSP) that are particularly useful in the processing and implementation of algorithms related to digital signals, such as voice data and communication signals, and microcontrollers that are useful in consumer applications, such as printers and copy machines. Any other number of processor cores will be in-line with the described embodiment.

A node 105 may include a system request interface (SRQ) 115. The SRQ 115 is configured to route communications from the processor cores 110a-110n to other devices such as the Northbridge 120. The Northbridge 120 routes transactions between the SRQ 115 and a RAM interface 160. A memory controller 125 may be located in the Northbridge 120. The memory controller 125 generally manages the flow of data going to and from RAM 160. In the illustrated embodiment, the RAM 160 is external to the integrated circuit device comprising the node 105. A crossbar (XBAR) 130 may be included in the Northbridge 120. The XBAR 130 may comprise circuitry configured to route communications between various sources and destinations. The sources may include Hypertransport (HT) 135 circuits, used for communication between nodes and between a node and a peripheral device, and the memory controller 125.

The system may also include a Southbridge 145. A Southbridge 145 is a chipset that normally supports slower devices such as input/output (I/O) devices 140. The Southbridge 145 may control power states of at least a part of the system based on messages and signals from processor cores, the Northbridge 120 or any other devices in the system. An I/O device 140 may be coupled to the Southbridge 145. A basic input/output system (BIOS) 150 may also be coupled to the Southbridge 145. BIOS 150 may be used to program address maps within a system and to determine the amount of memory needed by a node.

The system may include any number of nodes and processor cores, and the embodiments disclosed herein are equally applicable to a system configured differently.

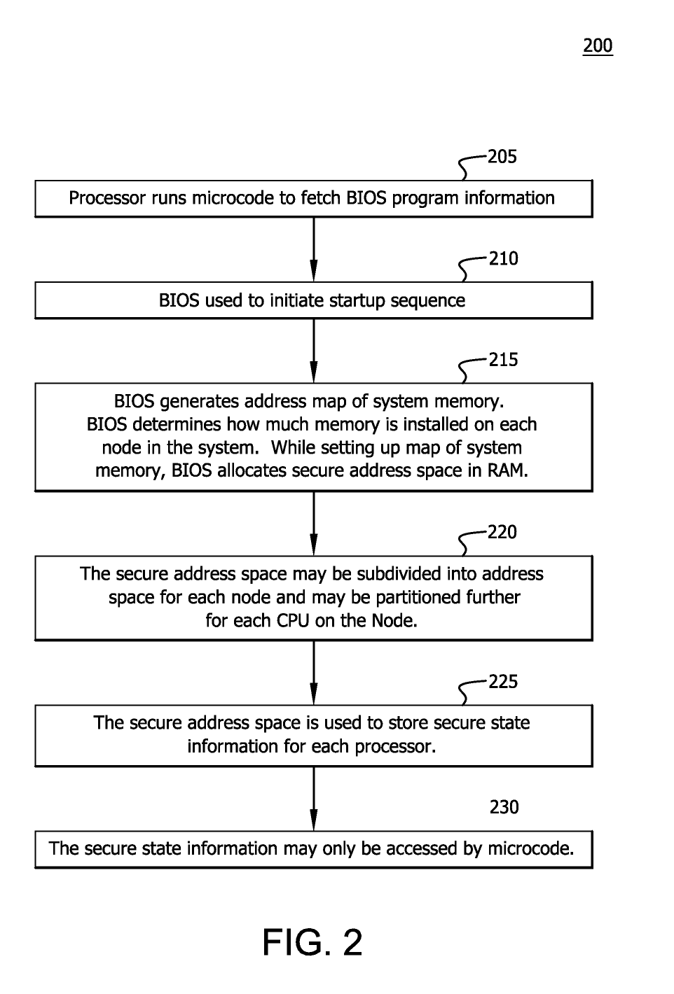

FIG. 2 is a flow diagram 200 of the process of allocating storage space in RAM. In a distributed memory system, each node is coupled to a memory device. Memory devices generally include volatile memory such as RAM. Also, in a distributed memory system, each node has its own memory controller which is coupled to one or more external memory devices. The information that would normally be stored in each node's internal memory may optionally be stored on a type of RAM such as dynamic random access memory (DRAM) that is external to the node and processor cores 110a-110n.

A processor core in each node contains startup microcode. At block 205, the processor core runs microcode upon each power up of the system, in order to proceed through a reset sequence and fetch BIOS program information (hereinafter “BIOS”) from a boot read-only memory (ROM) where boot code is integrated.

The BIOS is used to initiate the startup sequence for the system at block 210. At startup, the BIOS determines the number of nodes in a system, each node location, and the number of memory devices in the system. In addition, BIOS determines how much memory is installed on each node in the system at block 215 and generates a unified address map of the overall system. The address map specifies the address range in RAM attached to each node in the system.

The BIOS sets up routing tables and the unified address map on each node in block 215 in order to allow processor cores and I/O devices the ability to access memory on any node in the system.

In addition to setting up the address map, the BIOS may allocate storage space in RAM for each node in block 215. The storage space may include a secure address range used to store each node's state information. The secure address range is allocated at the top most portion of RAM and may be sub-divided for each node in block 220. The secure space may be further sub-divided for each processor core within a node in block 220. In block 225, the secure space may be used to store secure state information from each processor core. The secure address range in RAM is deemed private space and secure from any general purpose software. While other portions of RAM may be accessed, the secure address range in block 230 is not accessible by normal software and may only be accessed through the use of microcode.

TABLE 2

| Node | RAM | D18F1x [17C:140,7C:40] | |
|---|---|---|---|
| ID | Populated | [RAMBASE/RAMLIMIT] | C6 RAM Range |
| 0 | 256 MB | 0 MB, 240 MB-1 | 240 MB-256 MB-1 |

Table 2 shows an example of the address map containing one node. An address map may include information for multiple nodes. The address map shown in Table 2 contains a node identification field (NodeID). In addition, Table 2 shows the amount of RAM populated (e.g., 256 MB) by the node and the secure address range (i.e., C6 RAM Range) for the given node (e.g., 240 MB-256 MB−1). Also shown in Table 2 is a base and a limit address in RAM for the given node.

Microcode may use a special reserved physical address range, C6 RAM Range, to access the secure information in RAM. Normal software which uses a virtual address to access RAM and requires the virtual address to be translated in to a physical RAM address may be unable to issue a request to the C6 RAM Range. On a condition that general purpose software is able to issue a request to C6 RAM Range, the CPU will abort the request before the request is able to reach the C6 RAM Range.

BIOS may set a RAM Limit Address Register to exclude the secure address range in RAM from the address map. The exclusion of the secure address range may leave holes in the address map and may guarantee that the space may only be accessed through microcode and not by any other means 230.

BIOS may allocate secure storage space for all processor cores in the system in RAM on a single node or may allocate secure storage space in RAM on all nodes in the system. A secure storage area may be allocated in RAM on all nodes in the system in order to reduce remote access latency that is created when microcode stores and restores a save state in the local memory on a single node.

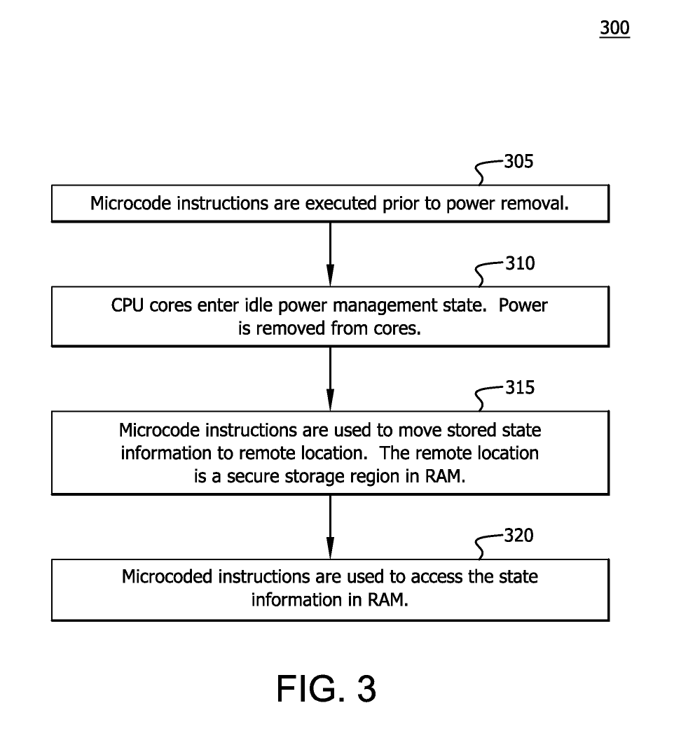

FIG. 3 is a flow diagram 300 of the process for storing state information in RAM. In block 305, prior to power removal from processor cores, the processor cores may execute requests. The requests may be divided into several complex instructions which specify multiple operations to be performed by the system. These multiple complex instructions may be decomposed into a set of operations. The set of operations is referred to as microcode, which may be executed directly on hardware. In block 310, once processor cores enter an idle power management state, power may be removed from the processor cores.

Microcoded instructions are stored in ROM and are used for processing complex operations. The complex operations may include, but are not limited to, flushing caches and encrypting state information at a time when power is removed from the processor cores. Microcode may also be used to store state information for each node locally. In block 315 microcode is used to move the locally stored state information to a remote location (i.e., from a CPU's ROM to RAM) which may be external to the node. Microcode may also be used to store architectural state and other hardware state information including cache RAM redundancy state information. In block 315 when microcode is used to move stored state information to a remote location, the remote location may be the secure storage region established in RAM.

When microcoded instructions are issued, the instructions may be issued to any address, since microcode is considered secure. In block 320 microcoded instructions may be used to access state information in RAM, where the state information is stored in the secure storage region. No other development software may obtain access to the information in the secure storage region.

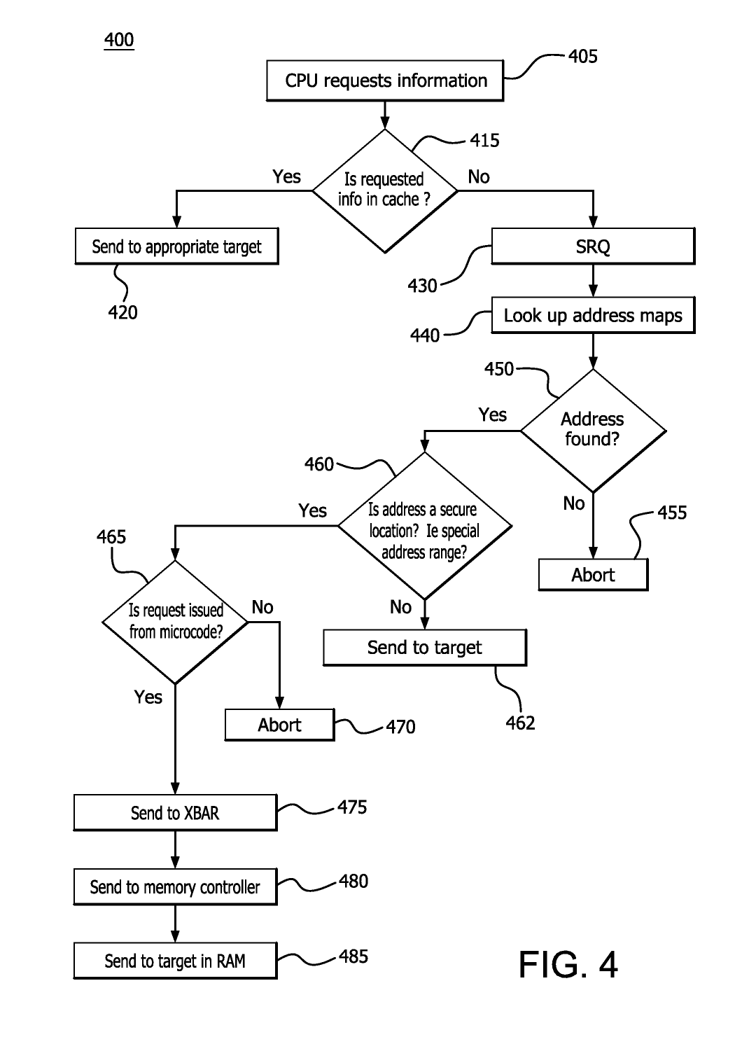

FIG. 4 is a flow diagram 400 of a request for information sent to RAM. In block 405, a request to either read or write data is made by the processor core. The requested data may be associated with a unique data address. Each unique data address is used to map the stored data in a memory device to a particular node.

In block 415 it is determined whether the requested data may be stored in a local memory device or in a local cache. If the requested data is cached or if its address is known, the request is sent to the appropriate target in block 420.

Normally, a request to an address range may be forwarded to the SRQ in block 430. The SRQ in block 430 includes memory address maps. If the requested data is not located in a cache, or its address is not known, the memory address maps in block 440 may be accessed. The memory address maps may contain unique data addresses. Memory address maps are created by BIOS and the maps are stored in each processor core. The memory address maps comprise a plurality of entries including ranges of memory address space for each node in a system. The memory address map may include a NodeID and a CPU ID. The NodeID in the address map may be used to route requests to the appropriate memory device. Address maps are accessed in order to determine which address the request may be transmitted to in order to read or write to the requested data.

There are several types of address maps, however, the request may hit only in one address map. In block 450 whether an address hits an address map is determined. If the address does not hit in any address map, the system may generate an abort message in block 455. If the address is found, it is determined whether or not it is in a secure location in block 460. If the address is not in a secure location, the request may be sent to the target in block 462. If the address is found, and it is in a secure location, whether the request issued from microcode is determined in block 465.

Microcode uses a special reserved address range (i.e., FDF7000000hex-FDF7ffffffhex) to store and retrieve private data securely. This address range is not expected to be found (i.e., hit) in any address map.

If the request did not issue from microcode, the request is aborted in block 470. If the request did issue from microcode, the request may be recognized as a C6 related operation and will be forwarded by the XBAR in block 475 and to the memory controller in block 480 of a node identified as a secure save area node. Normally, every system will have some reserved address range in the physical space for special uses such as system management commands, interrupts and configuration accesses. Once the request is recognized as a C6 related operation, the requested information is accessed in the secure area of RAM in block 485 and transmitted from RAM to the CPU via the memory controller.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Processors may be any one of a variety of processors such as a central processing unit (CPU) or a graphics processing unit (GPU). For instance, they may be x86 microprocessors that implement x86 64-bit instruction set architecture and are used in desktops, laptops, servers, and superscalar computers, or they may be Advanced RISC (Reduced Instruction Set Computer) Machines (ARM) processors that are used in mobile phones or digital media players. Other embodiments of the processors are contemplated, such as Digital Signal Processors (DSP) that are particularly useful in the processing and implementation of algorithms related to digital signals, such as voice data and communication signals, and microcontrollers that are useful in consumer applications, such as printers and copy machines. Although the embodiment may include one processor for illustrative purposes, any other number of processors will be in-line with the described embodiments.

What is claimed is:

1. A method by a processor for accessing state information in random access memory (RAM), the method comprising;
creating a secure address range in the RAM wherein the secure address range is only accessible through the execution of microcode;
storing state information in the secure address range in the RAM; and
sending a request using microcode to the secure address range in the RAM.

2. The method of claim 1 wherein microcode patches are stored in the RAM.

3. The method of claim 1 wherein the RAM is configured using basic input/output system (BIOS).

4. The method of claim 1 wherein on a condition that access is denied to the RAM an abort message is generated.

5. The method of claim 1 wherein the state information is stored in the RAM prior to the processor entering a lower power state.

6. The method of claim 1 wherein the state information is accessed in the RAM prior to the processor entering a higher power state.

7. The method of claim 1 wherein the processor is further configured to receive a response from the RAM.

8. The method of claim 1 wherein the secure address range in the RAM is sub-divided in an address space for each node in a system.

9. The method of claim 8 wherein a portion of the sub-divided address space is used to store the state information.

10. The method of claim 1 wherein an address map is created for the secure address range.

11. A system, comprising:
a processor configured to create a secure address range for a random access memory (RAM), wherein the secure address range can only be accessed through execution of microcode by the processor; and
a controller configured provide state information of the processor for storage in the secure address range of the RAM.

12. The system of claim 11 wherein microcode patches are stored in the RAM.

13. The system of claim 11 wherein the RAM is configured using basic input/output system (BIOS).

14. The system of claim 11 wherein on a condition that access is denied to the RAM an abort message is generated.

15. The system of claim 11 wherein the processor is further configured to receive a response from RAM.

16. The system of claim 11 wherein the state information is stored in the RAM prior to the processor entering a lower power state.

17. The system of claim 11 wherein the state information is accessed in the RAM prior to the processor entering a higher power state.

18. The system of claim 11 wherein the secure address range in the RAM is sub-divided in an address space for each node in a system.

19. The RAM of claim 18 wherein a portion of the sub-divided address space is used to store the state information.

20. The system of claim 11 wherein an address map is created for the secure address range.

21. A computer-readable storage medium storing instructions representing a design of an integrated circuit device, the integrated circuit device comprising:
a processor configured to create a secure address range wherein the secure address range can only be accessed by microcode; and
a controller configured to receive state information wherein the state information is stored in the secure address range.

22. The computer-readable storage medium of claim 21 wherein the instructions are Verilog data instructions.

23. The computer-readable storage medium of claim 21 wherein the instructions are hardware description language (HDL) instructions.
